(19) United States
(12) Patent Application Publication
(10) Pub. No.: US 2013/0010177 A1
(43) Pub. Date: Jan. 10, 2013

(54) DIGITAL PHOTOGRAPHING APPARATUS, METHOD OF CONTROLLING THE SAME, AND AUTO-FOCUSING METHOD

(75) Inventor: Hyung-ok Choi, Yongin-si (KR)

(73) Assignee: Samsung Electronics Co., Ltd., Suwon-si (KR)

(21) Appl. No.: 13/446,014

(22) Filed: Apr. 13, 2012

(30) Foreign Application Priority Data
Jul. 7, 2011 (KR) 10-2011-0067540

(51) Int. Cl. H04N 5/232

(52) U.S. Cl. 348/345; 348/E05.045

(57) ABSTRACT

A digital photographing apparatus includes a lens; a light dividing unit that divides incident light having passed through the lens into a first path and a second path; an imaging device that generates an image signal by performing photoelectric conversion using the incident light of the first path; an auto-focusing unit that generates a lens drive signal by using the incident light of the second path; and a lens driving unit that drives the lens by using the lens drive signal.

### CROSS-REFERENCE TO RELATED PATENT APPLICATION

This application claims the benefit of Korean Patent Application No. 10-2011-0067540, filed on Jul. 7, 2011, in the Korean Intellectual Property Office, the disclosure of which is incorporated herein in its entirety by reference.

### BACKGROUND

1. Field of the Invention

Embodiments relate to a digital photographing apparatus, a method of controlling the digital photographing apparatus, and an auto-focusing method.

2. Description of the Related Art

Digital photographing apparatuses receive an optical signal and convert the optical signal into an electrical signal to form a captured image. A path of the optical signal is controlled by a lens so as to adjust a focus in an imaging device. To this end, the digital photographing apparatuses perform an auto-focusing function for automatically adjusting a position of the lens.

### SUMMARY

Embodiments can provide a digital photographing apparatus, a method of controlling the digital photographing apparatus, and an auto-focusing method that may allow a separately formed auto-focusing optical system to generate an image signal and to rapidly and accurately perform auto-focusing (AF) without decreasing strength of an image signal generated.

Embodiments can also provide a digital photographing apparatus, a method of controlling the digital photographing apparatus, and an auto-focusing method that may allow a driving direction of a lens to be easily determined.

According to an aspect, there is provided a digital photographing apparatus including: a lens; a light dividing unit that divides incident light having passed through the lens into a first path and a second path; an imaging device that generates an image signal by performing photoelectric conversion using the incident light of the first path; an auto-focusing unit that generates a lens drive signal by using the incident light of the second path; and a lens driving unit that drives the lens by using the lens drive signal.

The light dividing unit may include a first reflector that transmits visible light of the incident light having passed through the lens and that reflects infrared light of the incident light having passed through the lens.

The auto-focusing unit may include: a second reflector that transmits a portion of light of the incident light of the second path and that reflects a portion of light of the incident light of the second path; a first sensor that generates a first detection signal by performing photoelectric conversion using the portion of light transmitted from the second reflector; a second sensor that generates a second detection signal by performing photoelectric conversion using the portion of light reflected from the second reflector; and an AF processing unit that generates the lens drive signal by using the first detection signal and the second detection signal.

A length of a first light path from the lens to the first sensor may be less than that of a second light path from the lens to the imaging device, and a length of a third light path from the lens to the second sensor is greater than that of the second light path from the lens to the imaging device.

If a difference between sizes of high-frequency components of the first detection signal and the second detection signal is less than a reference value, the AF processing unit may determine that a focus state is an in-focus state. If the size of the high-frequency component of the first detection signal is greater than that of the high-frequency component of the second detection signal, the AF processing unit may determine that the focus state is a front-focus state in which the incident light is in focus before the imaging device. If the size of the high-frequency component of the first detection signal is less than that of the high-frequency component of the second detection signal, the AF processing unit may determine that the focus state is a back-focus state in which the incident light is in focus after the imaging device.

If the focus state is determined to be the front-focus state, the AF processing unit may generate the lens drive signal used to move the lens toward the imaging device; and if the focus state is determined to be the back-focus state, the AF processing unit may generate the lens drive signal used to move the lens away from the imaging device.

According to another aspect, there is provided a method of controlling a digital photographing apparatus, the method including: extracting infrared light from incident light having passed through a lens; generating an image signal in an imaging device by using a remainder of the incident light; and performing auto-focusing by using the extracted infrared light.

The performing of the auto-focusing may include: dividing the infrared light into a path B and a path C; generating a first detection signal in a first sensor from the infrared light of the path B; generating a second detection signal in a second sensor from the infrared light of the path C; and determining a focus state by using the first detection signal and the second detection signal.

A length of the path B from the lens to the first sensor may be less than that of a light path from the lens to the imaging device, and a length of the path C from the lens to the second sensor may be greater than that of the path from the lens to the imaging device.

The determining of the focus state may include: if a difference between sizes of high-frequency components of the first detection signal and the second detection signal is less than a reference value, determining that the focus state is an in-focus state; if the size of the high-frequency component of the first detection signal is greater than that of the high-frequency component of the second detection signal, determining that the focus state is a front-focus state in which the incident light is in focus before the imaging device; and if the size of the high-frequency component of the first detection signal is less than that of the high-frequency component of the second detection signal, determining that the focus state is a back-focus state in which the incident light is in focus after the imaging device.

The method may further include, when the focus state is determined to be the front-focus state, moving the lens toward the imaging device; and when the focus state is determined to be the back-focus state, moving the lens away from the imaging device.

The generating of the image signal and the performing of the auto-focusing may be performed at the same time.

According to another aspect of the present invention, there is provided an auto-focusing method including: dividing incident light having passed through a lens into a path B and a path C; generating a first detection signal from the incident light of the path B in a first sensor; generating a second detection signal from the incident light of the path C in a second sensor; and determining a focus state by using the first detection signal and the second detection signal, wherein a length of a first path from the lens to the first sensor is less than a length of a light path from the lens to an imaging device, and a length of a second path from the lens to the second sensor is greater than the length of the light path from the lens to the imaging device.

The determining of the focus state may include: if a difference between sizes of high-frequency components of the first detection signal and the second detection signal is less than a reference value, determining that the focus state is an in-focus state; if the size of the high-frequency component of the first detection signal is greater than that of the high-frequency component of the second detection signal, determining that the focus state is a front-focus state in which the incident light is in focus before the imaging device; and if the size of the high-frequency component of the first detection signal is less than that of the high-frequency component of the second detection signal, determining that the focus state is a back-focus state in which the incident light is in focus after the imaging device.

The auto-focusing method may further include, if the focus state is determined to be the front-focus state, moving the lens toward the imaging device; and if the focus state is determined to be the back-focus state, moving the lens away from the imaging device.

### BRIEF DESCRIPTION OF THE DRAWINGS

The above and other features and advantages will become more apparent by describing in detail exemplary embodiments thereof with reference to the attached drawings in which:

FIG. 1 is a block diagram illustrating a structure of a digital photographing apparatus, according to an embodiment;

FIG. 2 is a flowchart illustrating a method of controlling a digital photographing apparatus, according to an embodiment;

FIG. 3 is a view illustrating a structure of a digital photographing apparatus, according to an embodiment;

FIG. 4 is a view illustrating an in-focus state in which an imaging device is in focus, according to an embodiment;

FIG. 5 is a view illustrating a back-focus state in which an imaging device is not in focus and a portion behind the imaging device is in focus, according to an embodiment;

FIG. 6 is a view illustrating a front-focus state in which an imaging device is not in focus and a portion before the imaging device is in focus, according to an embodiment; and

FIG. 7 is a flowchart illustrating an auto-focusing method, according to an embodiment.

### DETAILED DESCRIPTION

The following description and attached drawings are presented and used to understand operations according to the present invention, and a part that is obvious to one of ordinary skill in the art may not be described herein.

In addition, the specification and the attached drawings are provided not to limit the scope of the present invention, which should be defined by the claims. The terms used herein should be interpreted as having the meaning and concept most appropriate for the technical spirit of the present invention.

Hereinafter, embodiments will be described in detail with reference to the attached drawings.

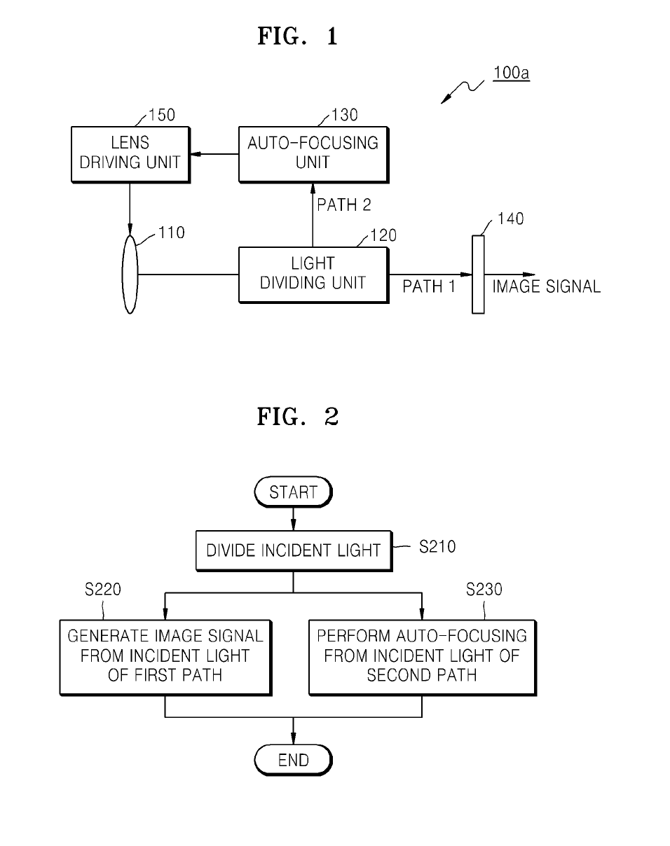

FIG. 1 is a block diagram illustrating a structure of a digital photographing apparatus 100a, according to an embodiment. The digital photographing apparatus 100a can include a lens 110, a light dividing unit 120, an auto-focusing unit 130, an imaging device 140, and a lens driving unit 150.

The lens 110 may include a plurality of groups including a focus lens, a zoom lens, etc., and a plurality of sheets of lenses. A position of the lens 110 may be adjusted by the lens driving unit 150. The lens driving unit 150 can adjust the position of the lens 110 according to a lens drive signal provided from the auto-focusing unit 130.

The light dividing unit 120 can divide incident light having passed through the lens 110 into a first path PATH1 and a second path PATH2. The light dividing unit 120 may, for example, be formed of a reflector for transmitting some light and reflecting some light. Alternatively, the light dividing unit 120 may be formed of a combination of a prism and a reflector. The light dividing unit 120 can guide incident light of the first path PATH1 to the imaging device 140 and can guide incident light of the second path PATH2 to the auto-focusing unit 130.

The imaging device 140 can perform photoelectric conversion using incident light of the first path PATH1 to generate an image signal. The imaging device 140 may be a charge coupled device (CCD) image sensor or a complementary metal oxide semiconductor image sensor (CIS) that can convert an optical signal into an electrical signal. A sensitivity of the imaging device 140 may be controlled by an imaging device controller (not shown). The imaging device controller may control the imaging device 140 according to a control signal that is automatically generated in response to an image signal input in real time or a control signal that is manually input by user's manipulation.

An exposure time of the imaging device 140 may be controlled by a shutter (not shown). The shutter may be a mechanical shutter for controlling entering of light by moving a cover or an electronic shutter for controlling light exposure by supplying an electrical signal to the imaging device 140.

An aperture (not shown) may be interposed between the lens 110 and the light dividing unit 120 to control exposure and depth of field.

The auto-focusing unit 130 can receive incident light of the second path PATH2 to generate a lens drive signal and can output the lens drive signal to the lens driving unit 150. The auto-focusing unit 130 may generate a detection signal for performing auto-focusing by using the incident light of the second path PATH2, may determine a focus state by using the detection signal, and can then generate the lens drive signal. The auto-focusing unit 130 can generate the lens drive signal by receiving feedback regarding the focus state. The auto-focusing unit 130 may perform auto-focusing by using any of various methods, for example, a phase difference auto-focusing method, a contrast auto-focusing method, or the like.

According to the current embodiment, the light dividing unit 120 can separate infrared light from incident light and can send the infrared light to the auto-focusing unit 130 through the second path PATH2 and the rest of the incident light, such as visible light, to the imaging device 140 through the first path PATH1. Since the imaging device 140 can mainly generate an image signal by using light of a visible light region, even though infrared light is not input thereto, strength of the image signal may not change much. Accordingly, since auto-focusing can be performed by using infrared light, continuous auto-focusing may be performed without decreasing the strength of the image signal.

FIG. 2 is a flowchart illustrating a method of controlling the digital photographing apparatus 100a, according to an embodiment.

In the method of controlling the digital photographing apparatus 100a according to the current embodiment, incident light having passed through the lens 110 can be divided into the first path PATH1 and the second path PATH2 (S210). According to the current embodiment, infrared light may be separated from the incident light to be sent to the second path PATH2.

Next, an image signal can be generated by using the incident light of the first path PATH1 (S220), and auto-focusing can be performed by using the incident light of the second path PATH2 (S230).

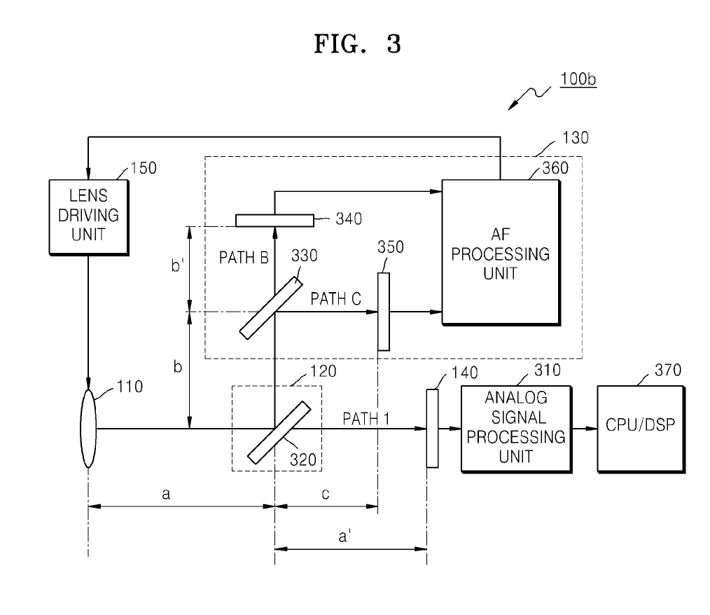

FIG. 3 is a view illustrating a structure of a digital photographing apparatus 100b, according to an embodiment.

The digital photographing apparatus 100b can include a lens 110, a light dividing unit 120, an auto-focusing unit 130, an imaging device 140, a lens driving unit 150, an analog signal processing unit 310, and a central processing unit (CPU)/digital signal processing (DSP) 370.

The light dividing unit 120 according to the current embodiment can include a first reflector 320 for transmitting some light and reflecting some light. Also, some light may be absorbed in the light dividing unit 120 and thus disappear.

According to the current embodiment, the first reflector 320 may be formed to transmit visible light and to reflect infrared light. The first reflector 320 may, for example, be formed of a low emissivity glass, metal alloy layers, or the like, wherein thicknesses of the metal alloy layers may be controlled to transmit visible light and to reflect infrared light and the metal alloy layers may be separated by a crosslinked polymeric spacing layer. The first reflector 320 can reflect infrared light and can send the infrared light to a second reflector 330 included in the auto-focusing unit 130 through a second path PATH2. The first reflector 320 can transmit the rest of the incident light to the imaging device 140 through a first path PATH1. The first reflector 320 may be formed of a material with a high transmittance of visible light and may be formed to have a structure with a high transmittance of visible light.

In the current embodiment, the first reflector 320 may reflect infrared light and can send the infrared light to the auto-focusing unit 130 and may send visible light to the imaging device 140 with no movement of the first reflector 320 when photographing is performed. Accordingly, since generation of an image signal and auto-focusing may be performed when the first reflector 320 is fixed, continuous auto-focusing may be performed during continuous photographing and video recording. Also, a speed of the continuous photographing may be remarkably increased. Furthermore, continuous auto-focusing may be performed in a live view mode, thereby providing a high quality live view.

The auto-focusing unit 130 can include the second reflector 330, a first sensor 340, a second sensor 350, and an AF processing unit 360.

The second reflector 330 can reflect some light of incident light of the second path PATH2 and can send the light to the second sensor 350 through a path C PATHC. The second reflector 330 can transmit the rest of the incident light and can send the light to the first sensor 340 through a path B PATHB. In this regard, light may be absorbed in the second reflector 330.

For example, the second reflector 330 may be formed to absorb half of the incident light and to reflect the other half of the incident light.

The first sensor 340 and the second sensor 350 can perform photoelectric conversion using incident light to generate a first detection signal and a second detection signal, respectively. The first sensor 340 and the second sensor 350 may be formed in various ways so as to detect a spatial frequency. For example, the first sensor 340 and the second sensor 350 may each be a black and white image sensor. Alternatively, the first sensor 340 and the second sensor 350 may each be a line sensor, for example, a horizontal line sensor, extending in one direction.

According to the current embodiment, a length of a light path from the lens 110 to the first sensor 340, i.e., a+b+b′, can be less than a length of a light path from the lens 110 to the imaging device 140, i.e., a+a′. A length of a light path from the lens 110 to the second sensor 350, i.e., a+b+c, can be greater than a length of a light path from the lens 110 to the imaging device 140, i.e., a+a′. From this configuration, it may be seen whether a current focus state is an in-focus state, a front-focus state, or a back-focus state.

The AF processing unit 360 can perform an auto-focusing function by using a first detection signal and a second detection signal respectively generated by the first sensor 340 and the second sensor 350 to generate a lens drive signal and provides the generated lens drive signal to the lens driving unit 150. The AF processing unit 360 can determine a focus state by extracting high-frequency components from the first detection signal and the second detection signal and by comparing sizes of the high-frequency components extracted from the first detection signal and the second detection signal.

According to the current embodiment, when light is not equally divided by the second reflector 330 into the path B PATHB and the path C PATHC, the AF processing unit 360 may apply weighted values to a first detection signal and a second detection signal according to a ratio at which light is divided by the second reflector 330. For example, when light intensities of the path B PATHB and the path C PATHC are in a 1 to 2 ratio, the AF processing unit 360 may apply a weighted value of 2 to the first detection signal and a weighted value of 1 to the second detection signal.

The analog signal processing unit 310 may perform noise reduction, gain adjustment, waveform shaping, analog-digital conversion, and the like on an image signal generated by the imaging device 140.

The CPU/DSP 370 may process an image signal provided from the analog signal processing unit 310 and control components included in the digital photographing apparatus 100b. The CPU/DSP 370 may reduce noise with respect to input image data and perform image signal processings for improving picture quality, for example, gamma correction, color filter array interpolation, color matrix, color correction, color enhancement, etc. The CPU/DSP 370 may also generate an image file by compressing image data on which the image signal processings have been performed or may restore image data from an image file. A compression format of an image may be a reversible type or an irreversible type. For example, when an image is a still image, the image may be converted according to a joint photographic experts group (JPEG) format or a JPEG 2000 format. Also, when a video is recorded, a video file may be generated by compressing a plurality of frames according to a moving picture experts group (MPEG) standard. Also, an image file may be generated according to an exchangeable image file format (EXIF) standard. Video files and image files may be stored in a predetermined storing unit (not shown).

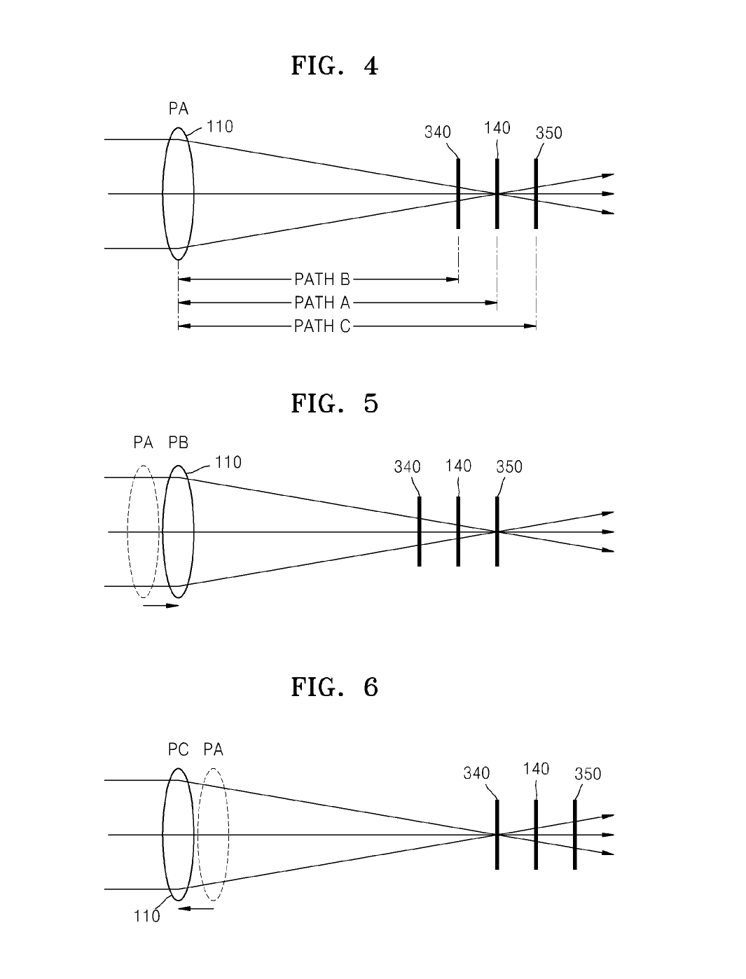

FIGS. 4 through 6 are views for describing a process of determining a focus state, according to an embodiment. In the current embodiment, the focus state can be detected by using a first detection signal and a second detection signal respectively detected by the first sensor 340 and the second sensor 350. In FIGS. 4 through 6, light paths from the lens 110 to the imaging device 140, from the lens 110 to the first sensor 340, and from the lens 110 to the second sensor 350 can be called a path A, a path B, and a path C, respectively.

As described above, according to the current embodiment, a length of the path B can be set to be less than that of the path A, and a length of the path C can be set to be greater than that of the path A. Also, according to the current embodiment, a difference between the lengths of the path A and the path B may be set to be equal to that between the lengths of the path C and the path A. That is, the lengths of the path A, the path B, and the path C may be set to satisfy the following conditions.

Length of path C>Length of path A>Length of path B (1)

Length of path C−Length of path A=Length of path A−Length of path B (2)

FIG. 4 is a view illustrating an in-focus state in which the imaging device 140 is in focus, according to an embodiment. In the in-focus state, the imaging device 140 can be in focus, and thus high-frequency components of a first detection signal and a second detection signal have low and similar values. That is, if a difference between the high-frequency components of the first detection signal and the second detection signal is less than a predetermined reference value REF, the AF processing unit 360 (see FIG. 3) may determine that the focus state is the in-focus state.

FIG. 5 is a view illustrating a back-focus state in which the imaging device 140 may not be in focus and a portion behind the imaging device 140 can be in focus, according to an embodiment. If the lens 110 moves from an in-focus position (PA) to a position closer to the imaging device 140 (PB), a portion behind the imaging device 140 can be in focus. In the back-focus state, since a portion around the second sensor 350 can be in focus, a size of a high-frequency component of a first detection signal can be small, and a size of a high-frequency component of a second detection signal can be large. Accordingly, a difference between the high-frequency components of the first detection signal and the second detection signal can be greater than the reference value REF. When the high-frequency component of the second detection signal is greater than that of the first detection signal, the AF processing unit 360 (see FIG. 3) can determine that the focus state is the back-focus state. In this case, the AF processing unit 360 can generate a lens drive signal used to move the lens 110 away from the imaging device 140 and can output the lens drive signal to the lens driving unit 150.

FIG. 6 is a view illustrating a front-focus state in which the imaging device 140 may not be in focus, and a portion before the imaging device 140 can be in focus, according to an embodiment. If the lens 110 moves from the in-focus position (PA) to a position further away from the imaging device 140 (PC), a portion before the imaging device 140 can be in focus. In the front-focus state, since a portion around the first sensor 340 can be in focus, a size of a high-frequency component of a second detection signal can be small, and a size of a high-frequency component of a first detection signal can be large. Accordingly, a difference between the high-frequency components of the first detection signal and the second detection signal can be greater than a reference value REF. When the high-frequency component of the first detection signal is greater than that of the second detection signal, the AF processing unit 360 (see FIG. 3) can determine that the focus state is the front-focus state. In this case, the AF processing unit 360 can generate a lens drive signal used to move the lens 110 toward the imaging device 140 and can output the lens drive signal to the lens driving unit 150.

As such, according to the current embodiment, since it may be seen whether the current focus state is the front-focus state or the back-focus state, a direction in which a lens is to be driven may be known, and thus an auto-focusing speed may be remarkably increased.

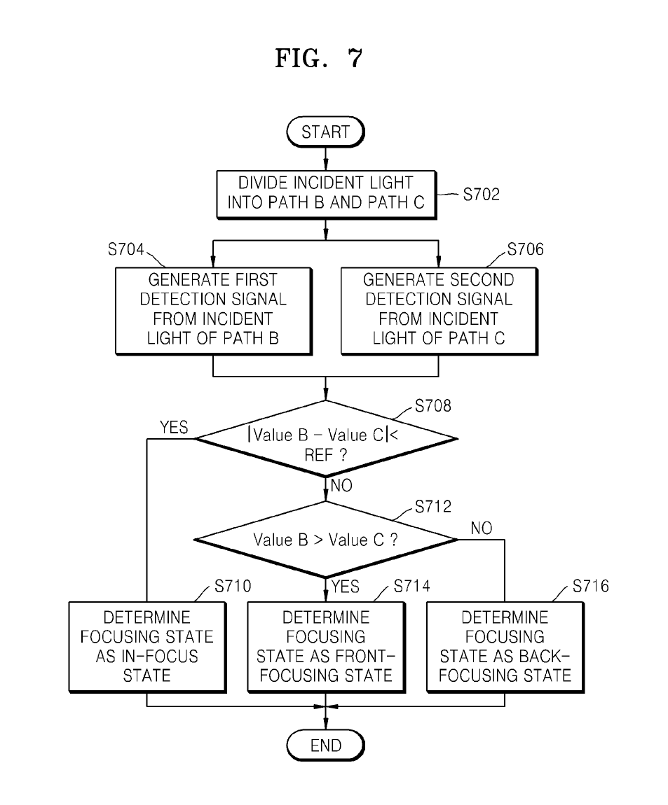

FIG. 7 is a flowchart illustrating an auto-focusing method, according to an embodiment.

First, incident light having passed through the lens 110 can be divided into the path B and the path C (S702). Next, a first detection signal can be generated from the incident light of path B (S704), and a second detection signal can be generated from the incident light of path C (S706). In this regard, the first detection signal may be generated in the first sensor 340 (see FIG. 3), and the second detection signal may be generated in the second sensor 350 (see FIG. 3). Also, a length of a light path from the lens 110 to the first sensor 340 may be less than that of a light path from the lens 110 to the imaging device 140, and a length of a light path from the lens 110 to the second sensor 350 may be greater than that of a light path from the lens 110 to the imaging device 140.

When a difference between sizes of a high-frequency component ValueB of the first detection signal and a high-frequency component ValueC of the second detection signal is less than a predetermined reference value REF (S708), a focus state can be determined to be an in-focus state (S710).

When a difference between the sizes of the high-frequency component ValueB of the first detection signal and the high-frequency component ValueC of the second detection signal is not less than the predetermined reference value REF (S708), the size of the high-frequency component ValueB of the first detection signal can be compared with the size of the high-frequency component ValueC of the second detection signal (S712). When the size of the high-frequency component ValueB of the first detection signal is larger than the size of the high-frequency component ValueC of the second detection signal (S712), the focus state can be determined to be a front-focus state (S714). When the size of the high-frequency component ValueC of the second detection signal is larger than the size of the high-frequency component ValueB of the first detection signal, the focus state can be determined to be a back-focus state (S716). When the focus state is determined to be the front-focusing state, a lens drive signal used to move the lens 110 toward the imaging device 140 can be generated, and when the focusing state is determined to be the back-focus state, a lens drive signal used to move the lens 110 away from the imaging device 140 can be generated.

According to the embodiments, the AF optical system can perform auto-focusing by using infrared light, and thus the auto-focusing can be rapidly and accurately performed without decreasing strength of an image signal.

Also, according to the embodiments, the AF optical system can easily determine a direction in which a lens is to be driven, and thus a speed of the auto-focusing can be increased.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention. The use of the terms “a” and “an” and “the” and similar referents in the context of describing the invention (especially in the context of the following claims) are to be construed to cover both the singular and the plural, unless the context clearly indicates otherwise. In addition, it should be understood that although the terms “first,” “second,” etc. may be used herein to describe various elements, these elements should not be limited by these terms, which are only used to distinguish one element from another. It will also be recognized that the terms “comprises,” “comprising,” “includes,” “including,” “has,” and “having,” as used herein, are specifically intended to be read as open-ended terms of art. The words “mechanism” and “element” are used broadly and are not limited to mechanical or physical embodiments, but may include software routines in conjunction with processors, etc. No item or component is essential to the practice of the invention unless the element is specifically described as “essential” or “critical”. Furthermore, recitation of ranges of values herein are merely intended to serve as a shorthand method of referring individually to each separate value falling within the range, unless otherwise indicated herein, and each separate value is incorporated into the specification as if it were individually recited herein. The use of any and all examples, or exemplary language (e.g., “such as”) provided herein, is intended merely to better illuminate the invention and does not pose a limitation on the scope of the invention unless otherwise claimed. Finally, the steps of all methods described herein can be performed in any suitable order unless otherwise indicated herein or otherwise clearly contradicted by context.

For the sake of brevity, conventional electronics, control systems, software development and other functional aspects of the systems (and components of the individual operating components of the systems) may not be described in detail. Also, the invention may employ any number of conventional techniques for electronics configuration, signal processing and/or control, data processing and the like. The apparatus described herein may comprise a processor, a memory for storing program data to be executed by the processor, a permanent storage such as a disk drive, a communications port for handling communications with external devices, and user interface devices, including a display, keys, etc.

When software modules are involved, these software modules may be stored as program instructions or computer readable code executable by the processor on a non-transitory computer-readable media, random-access memory (RAM), read-only memory (ROM), CD-ROMs, DVDs, magnetic tapes, hard disks, floppy disks, and optical data storage devices. The computer readable recording media may also be distributed over network coupled computer systems so that the computer readable code is stored and executed in a distributed fashion. This media can be read by the computer, stored in the memory, and executed by the processor. Where elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Also, using the disclosure herein, programmers of ordinary skill in the art to which the invention pertains can easily implement functional programs, codes, and code segments for making and using the invention.

The invention may be described in terms of functional block components and various processing steps. Such functional blocks may be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Functional aspects may be implemented in algorithms that execute on one or more processors. Furthermore, the connecting lines, or connectors shown in the various figures presented are intended to represent exemplary functional relationships and/or physical or logical couplings between the various elements. It should be noted that many alternative or additional functional relationships, physical connections or logical connections may be present in a practical device.

While the present invention has been particularly shown and described with reference to exemplary embodiments thereof, it will be understood that numerous modifications and adaptations will be readily apparent to those of ordinary skill in this art without departing from the spirit and scope of the present invention as defined by the following claims. Therefore, the scope of the invention is defined not by the detailed description of the invention but by the following claims, and all differences within the scope will be construed as being included in the invention.

What is claimed is:

1. A digital photographing apparatus comprising:
a lens;
a light dividing unit that divides incident light having passed through the lens into a first path and a second path;
an imaging device that generates an image signal by performing photoelectric conversion using the incident light of the first path;
an auto-focusing unit that generates a lens drive signal by using the incident light of the second path; and
a lens driving unit that drives the lens by using the lens drive signal.

2. The digital photographing apparatus of claim 1, wherein the light dividing unit comprises a first reflector that transmits visible light of the incident light having passed through the lens and that reflects infrared light of the incident light having passed through the lens.

3. The digital photographing apparatus of claim 1, wherein the auto-focusing unit comprises:
a second reflector that transmits a portion of light of the incident light of the second path and that reflects a portion of light of the incident light of the second path;
a first sensor that generates a first detection signal by performing photoelectric conversion using the portion of light transmitted from the second reflector;
a second sensor that generates a second detection signal by performing photoelectric conversion using the portion of light reflected from the second reflector; and
an AF processing unit that generates the lens drive signal by using the first detection signal and the second detection signal.

4. The digital photographing apparatus of claim 3, wherein a length of a first light path from the lens to the first sensor is less than that of a second light path from the lens to the imaging device, and a length of a third light path from the lens to the second sensor is greater than that of the second light path from the lens to the imaging device.

5. The digital photographing apparatus of claim 4, wherein if a difference between sizes of high-frequency components of the first detection signal and the second detection signal is less than a reference value, the AF processing unit determines that a focus state is an in-focus state; if the size of the high-frequency component of the first detection signal is greater than that of the high-frequency component of the second detection signal, the AF processing unit determines that the focus state is a front-focus state in which the incident light is in focus before the imaging device; and if the size of the high-frequency component of the first detection signal is less than that of the high-frequency component of the second detection signal, the AF processing unit determines that the focus state is a back-focus state in which the incident light is in focus after the imaging device.

6. The digital photographing apparatus of claim 5, wherein if the focus state is determined to be the front-focus state, the AF processing unit generates the lens drive signal used to move the lens toward the imaging device; and if the focus state is determined to be the back-focus state, the AF processing unit generates the lens drive signal used to move the lens away from the imaging device.

7. A method of controlling a digital photographing apparatus, the method comprising:
extracting infrared light from incident light having passed through a lens;
generating an image signal in an imaging device by using a remainder of the incident light; and
performing auto-focusing by using the extracted infrared light.

8. The method of claim 7, wherein the performing of the auto-focusing comprises:
dividing the infrared light into a path B and a path C;
generating a first detection signal in a first sensor from the infrared light of the path B;
generating a second detection signal in a second sensor from the infrared light of the path C; and
determining a focus state by using the first detection signal and the second detection signal.

9. The method of claim 8, wherein a length of the path B from the lens to the first sensor is less than that of a light path from the lens to the imaging device, and a length of the path C from the lens to the second sensor is greater than that of the path from the lens to the imaging device.

10. The method of claim 9, wherein the determining of the focus state comprises:
if a difference between sizes of high-frequency components of the first detection signal and the second detection signal is less than a reference value, determining that the focus state is an in-focus state;
if the size of the high-frequency component of the first detection signal is greater than that of the high-frequency component of the second detection signal, determining that the focus state is a front-focus state in which the incident light is in focus before the imaging device; and
if the size of the high-frequency component of the first detection signal is less than that of the high-frequency component of the second detection signal, determining that the focus state is a back-focus state in which the incident light is in focus after the imaging device.

11. The method of claim 10, further comprising:
when the focus state is determined to be the front-focus state, moving the lens toward the imaging device; and
when the focus state is determined to be the back-focus state, moving the lens away from the imaging device.

12. The method of claim 7, wherein the generating of the image signal and the performing of the auto-focusing are performed at the same time.

13. An auto-focusing method comprising:
dividing incident light having passed through a lens into a path B and a path C;
generating a first detection signal from the incident light of the path B in a first sensor;
generating a second detection signal from the incident light of the path C in a second sensor; and
determining a focus state by using the first detection signal and the second detection signal,
wherein a length of a first path from the lens to the first sensor is less than a length of a light path from the lens to an imaging device, and a length of a second path from the lens to the second sensor is greater than the length of the light path from the lens to the imaging device.

14. The auto-focusing method of claim 13, wherein the determining of the focus state comprises:
if a difference between sizes of high-frequency components of the first detection signal and the second detection signal is less than a reference value, determining that the focus state is an in-focus state;
if the size of the high-frequency component of the first detection signal is greater than that of the high-frequency component of the second detection signal, determining that the focus state is a front-focus state in which the incident light is in focus before the imaging device; and
if the size of the high-frequency component of the first detection signal is less than that of the high-frequency component of the second detection signal, determining that the focus state is a back-focus state in which the incident light is in focus after the imaging device.

15. The auto-focusing method of claim 14, further comprising:
if the focus state is determined to be the front-focus state, moving the lens toward the imaging device; and
if the focus state is determined to be the back-focus state, moving the lens away from the imaging device.
